(19) United States
(12) Patent Application Publication
(10) Pub. No.: US 2009/0138105 A1
(43) Pub. Date: May 28, 2009

(54) Method of controlling an irrigation system

(76) Inventor: Jeffrey A. Crawford, (US)

Correspondence Address: Jeffrey Crawford, 119 Hardin Place, Edgewater, FL, 32132, US

(21) Appl. No.: 11/840,977

(22) Filed: Aug. 19, 2007

(51) Int. Cl. G05D 7/06; G05B 9/02

(52) U.S. Cl. 700/79; 700/284

(57) ABSTRACT

The present invention is a method of controlling an irrigation system that minimizes the amount of irrigation water applied with the use of evapotranspiration (ET) to adjust the irrigation controller. By basing the irrigation program on run times which equal a specific amount of water, ET can be used as a percentage to adjust the amount of water applied during an irrigation cycle. By setting a run time to equal 1″ of rainfall ET can be used as a multiplier against the run time to make the correct adjustment to provide required water. By setting the amount of water to be applied to 2″ or any other amount would need an additional multiplier added to make the proper adjustment. Adjustments for landscape coefficient and distribution uniformity would be placed in run time formula based on use of ET set at 1″. The adjusted run time would be the input into the control system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING APPENDIX

Not Applicable

### THE FIELD OF INVENTION

The present invention relates generally to methods of controlling an irrigation system. More specifically, the present invention relates to methods of controlling an irrigation system to minimize the amount of irrigation water applied to a turf or crop while still meeting the crop or turf's water requirements. Still more specifically, the present invention relates to how ET is used to determine the amount of watering time necessary in an irrigation cycle to apply the proper amount of water.

### BACKGROUND

A feature in place to help conserve water is the water budget component available on the majority of new irrigation controllers. Solid state controllers have used water budget for many years. The use of water budget allows the user to adjust run time to all stations by one input. This input is a percentage multiplied into the run time programmed for each station. When the water budget is set at 100 percent the programmed time will be run. When water budget is set at 75 percent the run time will be decreased by 25 percent of programmed run time. A 40 minute station run time would be reduced 25% to a 30 minute run time. While water budgeting is a solution to easy adjustment of the controller, it still is based on what the end user input. It has no way of calculating the amount of water necessary for the watering cycle. Rain sensors are another tool for the conservation of water. They normally either allow the entire system to run, or shut the entire system off. They have an adjustment so the amount of water in inches needed to shut the system down can be set by the user. Rain sensors are a very effective product and are currently mandatory for most irrigation system installations. However, rain sensors do not measure the necessary requirements for irrigation and make no adjustments to run times. The system is on or off. No adjustment is made unless rainfall occurs in the amount required to shut system down.

The use of ET is currently being used to calculate the amount of irrigation that needs to be applied. The system has ET values programmed into controller in place of run times.

The values are placed into a formula which calculates how long each zone needs to run. While this is one the most effective ways to base water application it requires knowledge of precipitation rates and ET values.

Evapotranspiration, or “ET”, is the combination of water that is lost from the soil through evaporation and through transpiration from plants as a part of their metabolic processes. “Reference evapotranspiration” or “ETo” is simply the amount of water needed by a particular plant. As days get longer and warmer, ETo, or the plant's need for water, gradually increases. In FIG. 1, the shaded areas represent a very common, but incorrect watering practice, where the irrigation system is programmed by season rather than actual ET data. When controllers are not adjusted as water demand decreases and increases, excess water is used and wasted. At other times, the system may not put down the necessary application of water. The most efficient irrigation scheduling technique is to readjust the system run times to match the actual plant water needs, as shown by the ET water demand column on the chart.

Water management is a critical issue for water conservation throughout the country. The cost effective use of irrigation, which is dependent on the proper control of the irrigation system, is a major concern for all end users. The conservative use of water is an absolute necessity, especially by large users such as school districts, parks and golf courses. In today's world, water conservation is essential at all levels including residential and small commercial projects.

The use of ET in the last five years has become a priority for the use of large irrigation systems. The disadvantage of using ET is the understanding of how it works by the end user. It requires difficult programs and vast knowledge of irrigation. This has caused the use of ET to be limited within the irrigation industry. Some large systems have weather stations but this is not cost effective for the average or smaller irrigation system. New controls have the ability to call a weather station in a general area however, are still not cost effective and limit ET effectiveness to the location distance of the ET source from the actual site.

### BRIEF SUMMARY AND OBJECTS OF THE INVENTION

In view of the foregoing, it is the primary object of the present invention to provide a method of controlling an irrigation system with the use of ET that is more easily understood by the average end user of an irrigation system. By the average end user being able to understand how the system works, ET could be used by the majority of irrigation users. It is therefore one purpose of the present invention to provide an improved method of controlling an irrigation system wherein the watering event is defined by ET. The end user could have any type of weather station to automatically provide ET. The end user could manually input ET. The end user could program ET by historical data and have controller automatically adjust on a daily, weekly or monthly basis. The end user could make manual adjustments by adjusting run times. Another purpose of the present invention is to allow for the conservative use of water for irrigation purposes without an in depth knowledge of irrigation practices. Presently, the invention is to eliminate excessive use of water for irrigation purposes. By using this method of irrigation the end user would only apply the amount of water to maintain healthy crops or turf. Further, purpose of the present invention is to make the use of ET for irrigation adjustment more cost effective for every type of irrigation project.

### BRIEF DESCRIPTION OF THE DRAWING

FIG. 1 is a graphic comparison of ET water demand and typical season adjustment. Graph is hypothetical and the data is not derived from actual source. Graph is meant to show the concept of seasonal adjust versus true ET values.

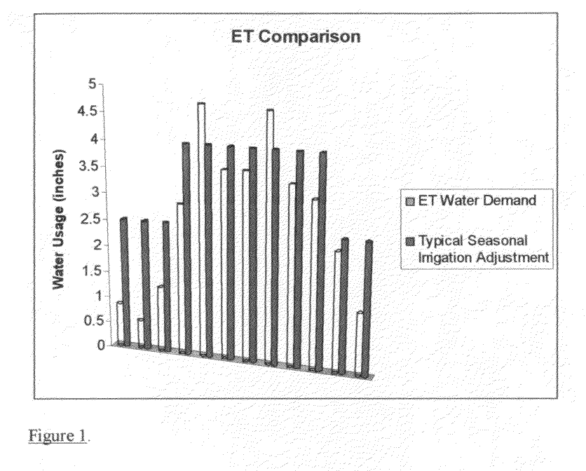

### DETAILED DESCRIPTION OF THE INVENTION

In order to appreciate the importance of the present invention, it is helpful to understand the amount of water used for irrigation. Studies have shown that irrigation has remained the largest use of freshwater in the United States and totaled 137 Bgal/d for 2000. Since 1950, irrigation has accounted for about 65 percent of total water withdrawals, excluding those for thermoelectric power. Historically, more surface water than ground water has been used for irrigation. However, the percentage of total irrigation withdrawals from ground water has continued to increase, from 23 percent in 1950 to 42 percent in 2000. Total irrigation withdrawals were 2 percent more for 2000 than for 1995, because of a 16-percent increase in ground-water withdrawals and a small decrease in surface-water withdrawals. Irrigated acreage more than doubled between 1950 and 1980, then remained constant before increasing nearly 7 percent between 1995 and 2000. The number of acres irrigated with sprinkler and micro-irrigation systems has continued to increase and now comprises more than one-half the total irrigated acreage (Hutson, et al., 2004).

If an irrigation system is operated according to the method of the present invention, then only the net irrigation required could be applied during each cycle of irrigation to maintain a healthy crop or turf.

### Run Time Calculations

### Where

T=sprinkler run time in minutes
60=constant for conversion of area, flow, inches per hour and inches per day into common units
ET₀=reference evapotranspiration rate, in inches per day
K_{c}=crop coefficient, decimal
PR=precipitation rate of the area, in inches per hour
IE=application efficiency of the system, percent

### Sprinkler Run Time

### Example 1

Calculation of run time to apply 1″ of water, where PR equals 1.5″

$$T = \frac{60 \times {ET}_{0}}{PR}$$

$$T = \frac{60 \times 1}{1.5}$$

T=40 minutes

### Example 2

Calculation of run time based on ET equal to 0.25, where PR equals 1.5″

$$T = \frac{60 \times .25}{1.5}$$

T=10 minutes

### Example 3

Calculation of run time based on run time equal to 1″ application rate with PR equal to 1.5″ multiplied by ET equal to 0.25.
T=40 minutes calculated time to apply 1″ x ET
T=40×0.25
T=10 minutes

The above examples are to prove that ET can be used as a percentage against run time and produce the same result as using precipitation rate calculation. Example 1 shows what the run time would need to be to apply 1″ of water. Example 2 shows what the run time would be using a precipitation rate based on 1.5″ of water and 0.25 ET value. Example 3 shows run time based at 1″ of water is than multiplied by 0.25 ET value to obtain the same value as determined in example 2.

Sprinkler run time with irrigation efficiency and crop coefficient

### Example 1

Calculation of run time to apply 1″ of water where PR equal to 1.5″, where K equal to 0.7 and where IE equal to 80 percent.

$$T = \frac{60 \times {ET}_{0} \times {K}_{C}}{PR \times IE}$$

$$T = \frac{60 \times 1 \times .7}{1.5 \times .8}$$

T=35 minutes

### Example 2

Calculation of run time based on ET equal to 0.2, PR equal to 1.5″, K equal to 0.7 and IE equal to 80 percent.

$$T = \frac{60 \times .2 \times .7}{1.5 \times .8}$$

T=7 minutes

### Example 3

Calculation of run time based on application of 1″ of water with precipitation rate equal to 1.5″, K equal to 0.7 and IE equal to 80 percent multiplied by ET equal 0.2.
T=35 minutes time calculated to provide 1″ with values set above x ET
T=35×0.2
T=7 minutes

The above examples are to prove that ET can be used as a percentage against run time and produce the same result as using precipitation rate calculation with the use of irrigation efficiency and landscape coefficient. Example 1 shows what the run time would need to be to apply 1″ of water. Example 2 shows what the run time would be using a precipitation rate based on 1.5″ of water and 0.2 ET value. Example 3 shows run time based at 1″ of water is than multiplied by ET to obtain the same value as defined in example 2. By calculating run times based on 1″ application of water with irrigation efficiency and landscape coefficients, ET can become a percentage of run time to make adjustment.

As shown above, by applying the run time based to apply 1″ of water based on any precipitation rate, ET becomes a percentage of the run time. This provides a much easier way of understanding how ET input will change the end users irrigation program. The preferred embodiment of the present invention described above is illustrative of the best embodiment know to the inventor, but should be considered as illustrative only and not limiting. The present invention should not be limited only by the scope of the appended claims.

1. A method of using ET changed into a percentage calculation that works similar to a water budget, which would make using ET a simplified method for controlling an irrigation system.

2. A method which would still involve the end user to input run times while utilizing an ET based irrigation system.

3. A method of using ET from either a manual or automatic input and changing the water application by ET becoming a percentage of run time.
